(19) United States
(12) Patent Application Publication
(10) Pub. No.: US 2012/0027981 A1
(43) Pub. Date: Feb. 2, 2012

(54) POLYETHYLENE CAPPING MATERIAL FOR WOOD COMPOSITE

(75) Inventor: Garry Glenn Belcher, JR., Greensboro, NC (US)

(73) Assignee: VIKING POLYMERS, LLC

(21) Appl. No.: 13/193,568

(22) Filed: Jul. 28, 2011

Related U.S. Application Data
(60) Provisional application No. 61/368,562, filed on Jul. 28, 2010.

(51) Int. Cl. B32B 27/32; B29C 47/06

(52) U.S. Cl. 428/68; 264/177.1

(57) ABSTRACT

A method of forming synthetic structural articles is provided. Crosslinking initiator is added to a polyolefin blend, which is co-extruded with a structural substrate. The polyolefin blend is partially crosslinked during the co-extrusion, leaving residual initiator to complete the thermoset process in a low temperature environment after the coating is applied. The polyolefin/initiator blend may be prepared as a powder or pre-extruded into pellets, during which some initial crosslinking may occur.

### CROSS-REFERENCE TO RELATED APPLICATIONS

This application claims benefit of U.S. Provisional Application Ser. No. 61/368,562 filed Jul. 28, 2010, which is herein incorporated by reference.

### BACKGROUND OF THE INVENTION

1. Field of the Invention

Embodiments of the invention relate to synthetic structural articles and methods of making synthetic structural articles. More specifically, embodiments described herein relate to durable coatings for structural articles and methods of making them.

2. Description of the Related Art

Wood structural members are slowly being replaced by synthetic structural members as their relative costs, direct and indirect, converge. Synthetic structural articles, however, remain defensive in high wear applications that require superior scratch and abrasion resistance. Thus, there is a need for synthetic structural articles having a highly durable surface, and methods for making such articles.

### SUMMARY OF THE INVENTION

Embodiments described herein provide a synthetic structural article including an extruded linear polymeric substrate and a polyolefin thermoset coating over the substrate.

Other embodiments provide a method of making a synthetic structural article by preparing a base stock for the structural article, preparing a coating stock for the structural article from a polyolefin blend and an initiator, co-extruding the structural article and a coating, the coating being reactively extruded from the coating stock to crosslink the polyolefin blend, and curing the coating to form a thermoset.

Other embodiments provide a method of forming a synthetic structural article by co-extruding a substrate and a coating on the substrate, the coating comprising a polyolefin blend crosslinked in three phases to form a thermoset, the three phases including extruding the polyolefin blend with an initiator to partially crosslink the polyolefin blend and leave a first residual concentration of initiator, co-extruding the polyolefin blend with the first residual concentration of initiator, forming the coating, further crosslinking the polyolefin blend, and leaving a second residual concentration of initiator, and curing the coated substrate, wherein curing the coated substrate includes further crosslinking the polyolefin blend to form the thermoset.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are schematic cross-sectional views of two structural articles according to two different embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

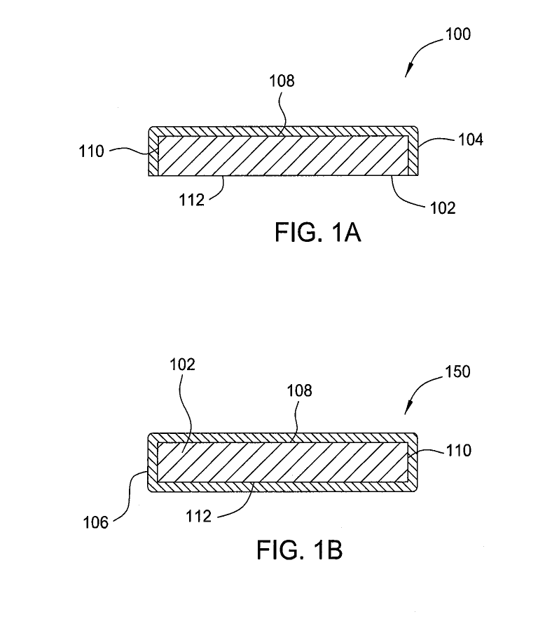

Embodiments described herein provide synthetic structural articles such as decking components, and methods of manufacturing such articles. FIGS. 1A and 1B are schematic cross-sectional views of two structural articles 100 and 150 according to two different embodiments. Each of the articles 100 and 150 has a substrate 102. The article 100 of FIG. 1A has a coating 104 that covers a first major surface 108 and two edges 110 of the substrate 102. The article 150 of FIG. 1B has a coating 106 that covers the first major surface 108 and a second major surface 112, and the two edges 110, of the substrate 102.

Substrates that may be coated to make structural articles as described herein include polymer/wood composite materials, solid polymeric materials, and foamed materials. Polyurethane, polyisocyanurate, polyolefin, styrenics, and PVC materials, and blends thereof, in solid, high-density foam, and low-density foam configurations may be used with embodiments described herein.

The coatings 104 and 106 are each a polyolefin thermoset formed by blending a crosslink initiator, such as a peroxide compound, with a polyolefin mixture and crosslinking the polyolefin mixture in two or three phases. In a two-phase process, the first phase comprises preparing polyolefin blend and initiator in powder form and extruding the coating from the powder mixture. The second phase comprises curing the coating in a low temperature process to form the polyolefin thermoset. In a three-phase process, the first phase comprises blending the polyolefin mixture with the initiator in a short residence time extrusion process. The polyolefin blend may be formed into pellets in some embodiments. The second phase comprises coating the substrate in a long residence time extrusion process. The third phase comprises curing the coating.

The polyolefin blend may comprise any suitable blend of polyolefins, including but not limited to LLDPE, LDPE, HDPE, and PP, which may be isotactic, syndiotactic, block, or random, with properties selected based on the processing required to make the structural article, and the final coating properties desired. The initiator may be a peroxide or silane compound or mixture selected to have half-life comparable to, or longer than, the total time required to make the coated structural. The degree of thermoplasticity desired in the polyolefin blend depends on the efficiency of the initiator, or initiator/inhibitor blend, and the heat history required to make the article. A higher efficiency initiator or initiator/inhibitor blend may be used with a more thermoplastic polyolefin blend (i.e. more PP in the blend) if the heat history of the article includes relatively long-duration low-temperature processes. A low efficiency initiator or initiator/inhibitor blend may be used with a less thermoplastic blend for short-duration processes that include more high-temperature heat history.

In the two-phase process, the first extrusion phase partially crosslinks the polyolefin blend to form a coating with properties that fall between thermoplastic properties and thermoset properties. The second phase comprises curing the coating at low temperature to complete the thermoset process. Partially crosslinking at elevated temperature and then curing at low temperature minimizes unwanted size reactions, such as oxidation, that may occur at higher temperatures. The finished product has a residue of initiator remaining in the coating that slowing catalyzes further setting of the coating, resulting in superior scratch and abrasion resistance, and excellent moisture barrier properties.

In the three-phase process, the first extrusion phase forms a polyolefin/initiator blend that partially crosslinks the polyolefin mixture prior to the coating process. The polyolefin mixture may be formed into pellets during the first phase. The polyolefin mixture retains substantial thermoplastic properties after the first phase of the three-phase process, and contains residual initiator that catalyzes further crosslinking during the coating process. The first phase of the three-phase process may be a short residence time phase to avoid substantially crosslinking the polyolefin mixture prior to coating. In both the two-phase and three-phase processes, the coating phase, which is the second phase of the three-phase process, is a relatively long residence time phase in which the polyolefin mixture is co-extruded with the substrate, partially crosslinking the polyolefin mixture to form a polymer coating with residual thermoplasticity. Residual initiator then completes the thermoset process in the third phase, which is a low temperature slow crosslinking process.

In most embodiments, the coating is applied as a thin layer having thickness between about 0.0045 inches and 0.06 inches for a nominally one inch thick substrate. Coating stock blends may further comprise pigments and antioxidants in some embodiments.

While the foregoing is directed to embodiments of the invention, other and further embodiments of the invention may be devised without departing from the basic scope thereof.

What is claimed is:

1. A synthetic structural article, comprising:
an extruded linear polymeric substrate; and
a polyolefin thermoset coating over the substrate.

2. A method of making a synthetic structural article, comprising:
preparing a base stock for the structural article;
preparing a coating stock for the structural article, the coating stock comprising a polyolefin blend and an initiator;
co-extruding the structural article and a coating, the coating being reactively extruded from the coating stock to crosslink the polyolefin blend; and
curing the coating to form a thermoset.

3. A method of forming a synthetic structural article, comprising:
co-extruding a substrate and a coating on the substrate, the coating comprising a polyolefin blend crosslinked in three phases to form a thermoset, the three phases comprising:
extruding the polyolefin blend with an initiator to partially crosslink the polyolefin blend and leave a first residual concentration of initiator;
co-extruding the polyolefin blend with the first residual concentration of initiator, forming the coating, further crosslinking the polyolefin blend, and leaving a second residual concentration of initiator; and
curing the coated substrate, wherein curing the coated substrate comprises further crosslinking the polyolefin blend to form the thermoset.
